(19) United States
(12) Patent Application Publication
(10) Pub. No.: US 2015/0142797 A1
(43) Pub. Date: May 21, 2015

(54) ELECTRONIC DEVICE AND METHOD FOR PROVIDING MESSENGER SERVICE IN THE ELECTRONIC DEVICE

(71) Applicant: Samsung Electronics Co., Ltd., Gyeonggi-do (KR)

(72) Inventors: You-Bi SEO, Seoul (KR); Sung-Ju PARK, Seoul (KR); Chun-Hyoung PARK, Incheon (KR)

(73) Assignee: Samsung Electronics Co., Ltd., Gyeonggi-do (KR)

(21) Appl. No.: 14/291,306

(22) Filed: May 30, 2014

(30) Foreign Application Priority Data
Nov. 20, 2013 (KR) 10-2013-0141541

(51) Int. Cl. G06F 17/30; H04L 12/58

(52) U.S. Cl. CPC G06F 17/30522; H04L 51/04
USPC 707/736

(57) ABSTRACT

An electronic device and a method providing a messenger service in the electronic device are provided. The electronic device includes a display configured to display a timeline bar in a dialogue window of a messenger application, the timeline bar including a plurality of time points, each time point associated with archived messages, and a controller configured to receive a selection of one of the time points and retrieve the archived messages associated with the selected one of the time points, and display the retrieved archived messages.

### CROSS-REFERENCE TO RELATED APPLICATION(S)

This application claims the benefit under 35 U.S.C. §119(a) of a Korean patent application filed in the Korean Intellectual Property Office on Nov. 20, 2013 and assigned Serial No. 10-2013-0141541, the entire disclosure of which is incorporated herein by reference.

### TECHNICAL FIELD

The present disclosure relates generally to an electronic device, and more particularly, to a method for providing a messenger service in an electronic device.

### BACKGROUND

With the proliferation of electronic devices, there is increased demand for User Interfaces (UIs) with intuitive input/output functionality. For example, UIs of electronic devices have evolved from traditional UIs that receive information through peripherals such as a keyboard, a keypad, a mouse, and the like to intuitive UIs that receive information via a touch inputs made to a screen with a finger, electronic touch pen or even by voice. UI technology is important to facilitate more convenient and easier control of an electronic device.

Electronic devices may provide an instant messenger service as a useful communication tool for delivering messages in real time. An instant transmits a simple message in real time between two users. With the instant messenger, two or more users may talk with each other via text, as if they were talking face to face. This is possible because of the real-time features of the instant messenger in that it immediately transmits received information on command. Exchanged messages may be archived according to a time order, and a user may retrieve and read achieved messages in the messenger.

However, if the number of archived messages is large, a conventional messenger may not provide a sufficiently efficient UI that enables easy reading of archived messages. Therefore, the user may be required to enter inputs to retrieve a desired archives message for viewing in the messenger.

For example, the user may be forced to scroll excessively through old messages, starting from a current message. The user may also be forced to search for a message sent or received on a designated date by checking message dialogues one date at a time.

### SUMMARY

One aspect of the present disclosure provides an electronic device and a method for providing a messenger service in the electronic device, enabling a user to easily move from a dialogue window to a previous message through an intuitive user-friendly User Interface (UI).

Another aspect of the present disclosure is to provide an electronic device and a method for providing a messenger service in the electronic device, which can rapidly identify and retrieve a dialogue made on a selected date simply by the user's choosing the date in a dialogue window.

In one aspect of this disclosure, an electronic device providing a messenger service is disclosed. The electronic device includes a display configured to display a timeline bar in a dialogue window of a messenger application, the timeline bar including a plurality of time points, each time point associated with archived messages; and a controller configured to receive a selection of one of the time points and retrieve the archived messages associated with the selected one of the time points, and display the retrieved archived messages.

In another aspect of this disclosure, a method for providing a messenger service in an electronic device, the method including displaying, via a display, a timeline bar in a dialogue window of a messenger application, the timeline bar including a plurality of time points, each time point associated with archived messages; and receiving, via a controller, a selection of one of the time points and retrieving the archived messages associated with the selected one of the time points, and displaying the retrieved archived messages.

Other aspects of the disclosure will become apparent to those skilled in the art from the following detailed description, which, taken in conjunction with the annexed drawings, discloses example embodiments of the disclosure.

### BRIEF DESCRIPTION OF THE DRAWINGS

The example embodiments of the present disclosure will be more apparent from the following description taken in conjunction with the accompanying drawings, in which:

FIG. 1 conceptually illustrates an example messenger service system according to an embodiment of the present disclosure;

FIG. 2 is a block diagram of an example electronic device according to an embodiment of the present disclosure;

FIG. 3 is a flowchart illustrating an example operation for providing a messenger service in an electronic device according to an embodiment of the present disclosure;

FIG. 4 is a flowchart illustrating an example operation for displaying a timeline bar in a dialog window according to an embodiment of the present disclosure;

FIG. 5A, and FIG. 5B illustrate example timeline bars displayed in a dialogue window according to an embodiment of the present disclosure;

FIG. 6A, FIG. 6B, and FIG. 6C illustrate examples of displaying dates on a timeline bar according to an embodiment of the present disclosure;

FIG. 7A, FIG. 7B, and FIG. 7C illustrate examples of displaying a timeline bar in a dialogue window according to an embodiment of the present disclosure; and

FIG. 8A and FIG. 8B illustrate example screens displayed upon selection of a date on a timeline bar according to an embodiment of the present disclosure. Throughout the drawings, like reference numerals will be understood to refer to like parts, components, and structures.

### DETAILED DESCRIPTION

The following description with reference to the accompanying drawings is provided to assist in a comprehensive understanding of example embodiments of the disclosure as defined by the claims and their equivalents. It includes various specific details to assist in that understanding, but these are to be regarded as mere examples. Accordingly, those of ordinary skill in the art will recognize that various changes and modifications of the embodiments described herein can be made without departing from the ambit of the disclosure. In addition, descriptions of well-known functions and implementations may be omitted for clarity and conciseness.

The terms and words used in the following description and claims are not limited to the bibliographical meanings, but, are merely used to enable a clear and consistent understanding of the disclosure. Accordingly, it should be apparent to those skilled in the art that the following description of example embodiments of the present disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

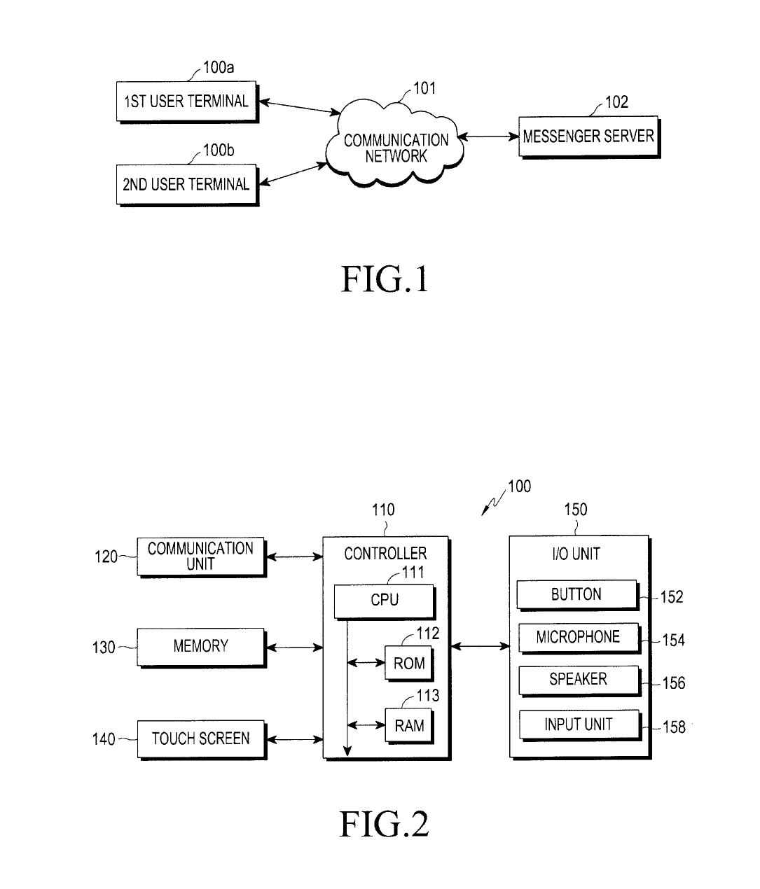

FIG. 1 illustrates an example messenger service system according to an embodiment of the present disclosure. A messenger service system may include user terminals including a first user terminal 100a and a second user terminal 100b, a communication network 101, and a messenger server 102.

Upon receipt of a request for a dialogue with another user, the messenger server 102 may check for the presence of the other user (such as state information about the other user), establish a dialogue channel between the two users, and provide a messenger service to the users. For example, once a dialogue channel is established between the first user terminal 100a and the second user terminal 100b, messages between the first user terminal 100a and the second user terminal 100b may be transmitted to the respectively addressed user terminal through the messenger server 102. The messenger server 102 may store transmitted messages. For example, the messenger server 102 may store dialogues including messages exchanged between user terminals, according to a time order or date order. Upon receipt of a request for a previous dialogue from a user terminal, the messenger server 102 may provide the user terminal with the stored previous dialogue in response to the request. While the first and second user terminals 100a and 100b are taken as an example, messages from a plurality of user terminals (not shown) may be delivered to their corresponding user terminals. A message written in each of the plurality of user terminals may be displayed in a messenger dialogue window of the user terminal In the dialogue window, a timeline bar may be displayed, by which a user may move to a dialogue made on a desired date represented, for example, in hour, day, week, month, and year.

In various embodiments of the present disclosure, a user terminal may be an electronic device. The electronic device may be a device with communication capabilities in an embodiment of the present disclosure. For example, the electronic device may include at least one of a smartphone, a tablet Personal Computer (PC), a mobile phone, a video phone, an e-Book reader, a desktop PC, a laptop PC, a Netbook computer, a Personal Digital Assistant (PDA), a Portable Multimedia Player (PMP), an MP3 player, mobile medical equipment, a camera, or a wearable device (such as, for example, a head mounted display “HMD” like electronic glasses, electronic clothes, an electronic bracelet, an electronic necklace, an electronic accessory, or a smart watch).

In various embodiments of the present disclosure, the electronic device may be a smart home appliance with communication capabilities. For example, the smart home appliance may include at least one of a Television (TV), a Digital Versatile Disk (DVD) player, an audio player, a refrigerator, an air conditioner, a cleaner, an oven, a washing machine, an air cleaner, a set-top box, a TV box (for example, Samsung HomeSync™, Apple TV™, Google TV™, or the like), a game console, an electronic dictionary, a camcorder, or an electronic frame.

In embodiments of the present disclosure, the electronic device may include at least one of a navigator or an in-vehicle infotainment device.

In embodiments of the present disclosure, the electronic device may include at least one of furniture, a part of a building/structure, an electronic board, an electronic signature receiver, or a projector, which have communication capabilities. The electronic device of the present disclosure may be one or a combination of two or more of the above various devices. It will be apparent to those skilled in the art that the electronic device according to various embodiments of the present disclosure is not limited to the afore-mentioned devices.

FIG. 2 is a block diagram of an example electronic device according to an embodiment of the present disclosure.

Referring to FIG. 2, the electronic device may include a controller 110, a communication unit 120, a memory 130, a touch screen 140, and an Input/Output (I/O) unit 150.

The controller 110 may include a Central Processing Unit (CPU) 111, a Read Only Memory (ROM) 112, and a Random Access Memory (RAM) 113. Or the controller 110 may include a Digital Signal Processor (DSP). The ROM 112 may store a control program to control the electronic device 100. The RAM 113 may store signals or data received from the outside of the electronic device 100 or may be used as a memory space for an operation performed by the electronic device 100. The CPU 111 may include one or more cores. The CPU 111, the ROM 112, and the RAM 113 may be interconnected through an internal bus.

The controller 110 may control the mobile communication unit 120, the touch screen 140, and the I/O unit 150. The controller 110 provides overall control to the electronic device 100 and may control a signal flow between components of the electronic device 100.

For example, the controller 110 may perform a messenger function as described in various embodiments of the present disclosure. During executing the messenger function, the controller 110 may control the touch screen 140 to display a timeline bar in a dialogue window. For example, if the electronic device 100 is placed in a state in which a timeline bar is supposed to be displayed in a dialogue window activated on the touch screen 140 according to the messenger function, the controller 110 may control display of the timeline bar in the dialogue window. Upon user selection of a specific time point on the timeline bar in the dialogue window, the controller 110 may control display of a dialogue made at the selected time point, for example, on the selected time point represented in hour, day, week, month, or year. Herein, the controller 110 may receive dialogue content made during a selected time period from the messenger server 102, and control display of dialogue content.

The controller 110 may control display of a time period on the timeline bar in a variety of ways. For example, the controller 110 may control display of time points at which dialogue were made on the timeline bar, or control display of time points at predetermined intervals on the timeline bar.

The communication unit 120 may connect the electronic device 100 to an external device. The external device may include a portable phone (not shown), a smart phone (not shown), a tablet PC (not shown), and a server. The mobile communication unit 120 may connect the electronic device 100 to an external device by mobile communication through one or more antennas (not shown) under the purview of the controller 110. The mobile communication unit 120 may transmit wireless signals to or receive wireless signals from a portable phone (not shown), a smart phone (not shown), a tablet PC (not shown), or another device (not shown) that has a phone number input to the electronic device 100, for a voice call, a video call, a Short Message Service (SMS), or a Multimedia Messaging Service (MMS). The mobile communication unit 130 may further include at least one of a Wireless Local Area Network (WLAN) module (not shown) or a short-range communication module (not shown). The WLAN module may be connected to the Internet in a place where a wireless AP (not shown) is installed. The WLAN module may support a WLAN standard, Institute of Electrical and Electronics Engineers (IEEE) 802.11x. The short-range communication module may conduct short-range wireless communication between the electronic device 100 and an image forming device (not shown) under the control of the controller 110. The short-range communication may conform to Bluetooth, Infrared Data Association (IrDA), or the like. The communication unit 129 may access the messenger server 102 and thus may transmit or receive a dialogue message to or from the messenger server 102, or receive a dialogue from the messenger server 102 under the control of the controller 110.

The memory 130 may store input/output signals or data, in accordance with operations of the mobile communication unit 120, the touch screen 140, and the I/O module 150 under the control of the controller 110. The memory 130 may store a plurality of programs and a plurality of applications to control the display device 100 or the controller 110, and programs and data to execute various functions. In various embodiments of the present disclosure, the memory 130 may store various messenger service functions.

The term “memory” covers the ROM 112 and the RAM 113 within the controller 110, or a memory card (not shown) (e.g., a Secure Digital “SD” card or a memory stick) mounted to the electronic device 100. The memory 130 may include a non-volatile memory, a volatile memory, a Hard Disk Drive “HDD”, or a Solid State Drive “SSD.”

The memory 130 may be a machine-readable medium (for example, a computer-readable medium). A machine-readable medium refers to a medium that provides data to a machine so that the machine may execute a specific function. The machine-readable medium may be a storage medium. The memory 130 may include a non-volatile medium and/or a volatile medium. Any such mediums should be of medium-types that are capable of storing and transmitting commands detectable by a physical device that reads the commands to a machine. The machine-readable medium may include, but is not limited to, at least one of a floppy disk, a flexible disk, a hard disk, a magnetic tape, a Compact Disc Read Only Memory (CD-ROM), an optical disk, a punch card, a paper tape, a RAM, a Programmable Read Only Memory (PROM), an Erasable PROM (EPROM), or a Flash EPROM.

The touch screen 140 may include a display and provide User Interfaces (UIs) for executing various functions. For example, the touch screen 140 may provide a Graphical User Interface (GUI) corresponding to a messenger service and may display a dialogue window including a timeline bar. The timeline bar includes at least one of selectable time points, for example, time, date, week, month, or year. The touch screen 140 may receive a user input via a user gesture, including variations such as touching or approaching the touch screen 140 with a user's body part (such as, for example, a finger) or a touch input means (such as, for example, a pen). The touch screen 140 may provide information corresponding to a specific time point selected on the timeline bar by a user input, such as, for example, a time, a date, a week, a month, or a year. The touch screen 140 may be implemented, for example, as a resistive type, a capacitive type, an infrared type, or an acoustic wave type. The touch screen 140 may include a sheet for recognizing an ElectroMagnetic (EM) device (such as, for example, a pen). The I/O unit 150 may include, but is not limited to, buttons 152, a microphone 154, a speaker 156, and an input unit 158. A cursor controller, such as a mouse, a track ball, a joy stick, or cursor directional keys may be provided for communication with the controller 110, and control of cursor movement on the touch screen 140.

The microphone 154 may receive a voice or a sound, which it converts to an electrical signal. The speaker 156 may output sounds corresponding to various signals (e.g., a wireless signal, a broadcast signal, a digital audio file, a digital video file, a photo shot, etc.) received from the mobile communication unit 120 or generated upon execution of applications to the outside of the electronic device 100.

The input unit 158 may be a device or object that is configured to be inserted and stowed inside the electronic device 100, or alternatively, it may be stowed separately. In the former case, the input unit 158 may be extended or detached from the electronic device 100. The input unit 158 may be an input means capable of applying an input by approaching or touching the touch screen 140, such as a stylus pen (hereinafter, referred to as a pen) or a user's finger. A user may apply an input with the input unit 158.

Now a description will be given of an operation providing a messenger service in the electronic device 100 having the above-described configuration.

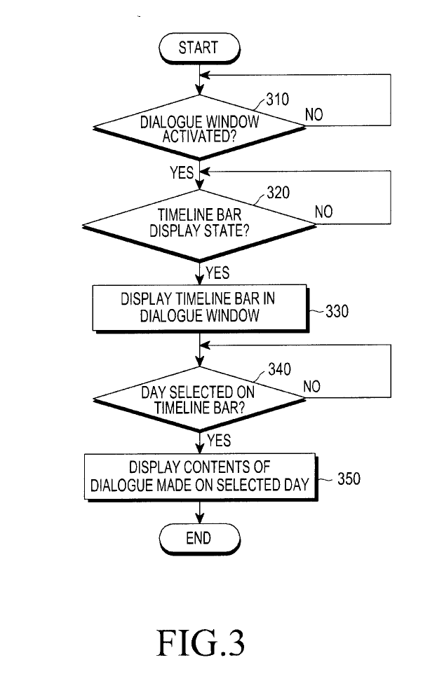

FIG. 3 is a flowchart illustrating an example operation for providing a messenger service in an electronic device according to an embodiment of the present disclosure. The electronic device 100 may determine whether a dialogue window has been activated in operation 310. For example, upon execution of a messenger function, the electronic device 100 may activate a dialogue window. When the dialogue window is activated, the dialogue window may be displayed on the touch screen 140. The dialogue window may include a message input area in which a message to be transmitted to the other party is input and a display area in which a dialogue made with the other party is displayed.

Upon activation of the dialogue window, the electronic device 100 may determine whether a timeline bar display state has been set in operation 320. If the timeline bar display state has been set, the electronic device 100 may display a timeline bar in at least a part of the dialogue window in operation 330. The timeline bar may display time in hours, days, weeks, months, or years. The timeline bar may display time in hour 1 to hour 24, day 1 to day 31, weeks, January to December, or years spanning a predetermined period. The timeline bar may display time in a variety of formats encompassing different sets of data, such as in “hours and days;” in “hours, days, and weeks;” in “hours, days, weeks, and months;” or in “hours, days, weeks, months, and years.” For example, the timeline bar may display time in hours, in days, in weeks, in months, or in years, and the unit of time may be optionally changed to at least one of an hour, day, week, month, or year. The unit of time in which time is displayed on the timeline bar may therefore be changed according to a user setting.

In various embodiments of the present disclosure, time on the timeline bar may be represented in “days,” “days and months,” “days, months, and years,” etc. by way of example. However, it is apparent to those skilled in the art that other embodiments may be implemented by using different units of time on the timeline bar. The following description is thus given with the appreciation that a selected unit of time is a “day,” by way of example. However, a selected time may alternatively be an hour, a week, a month, or a year, etc.

When the timeline bar is displayed in the dialogue window, the electronic device 100 may determine whether a time point, (such as, for example, a day) has been selected on the timeline bar in operation 340. For example, if a specific day on the timeline bar is touched by a user's finger or the input unit 158, the electronic device 100 may determine that the specific day is selected.

In operation 350, upon selection of a day on the timeline bar, the electronic device 100 may display a dialogue made on the day in the dialogue window of the touch screen 140. Herein, the electronic device 100 may receive the dialogue of the selected day from the messenger server 102 through the communication unit 120 and display the received dialogue. Or, the electronic device 100 may search for the dialogue of the selected day in the memory 130, and retrieve and display the dialogue.

In accordance with an example embodiment of the present disclosure, once the user selects a day displayed in the dialogue window, the electronic device 100 may immediately display dialogue content made on the selected day by the user. Therefore, there is no need for repetitious scrolling through previous messages, starting from a current message. Further, the user does not need to search for a message sent or received on an intended date by checking dialogues one by one, starting from a dialogue on a current date.

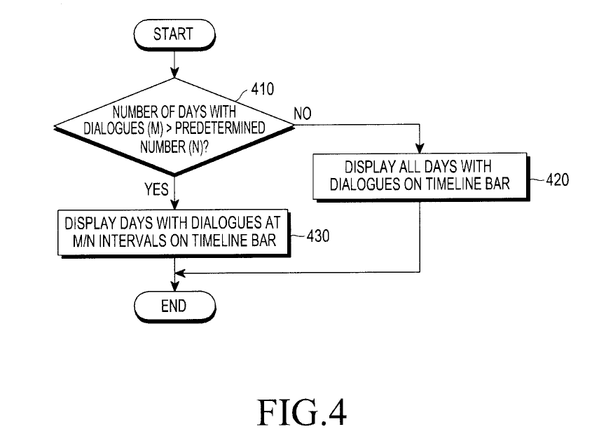

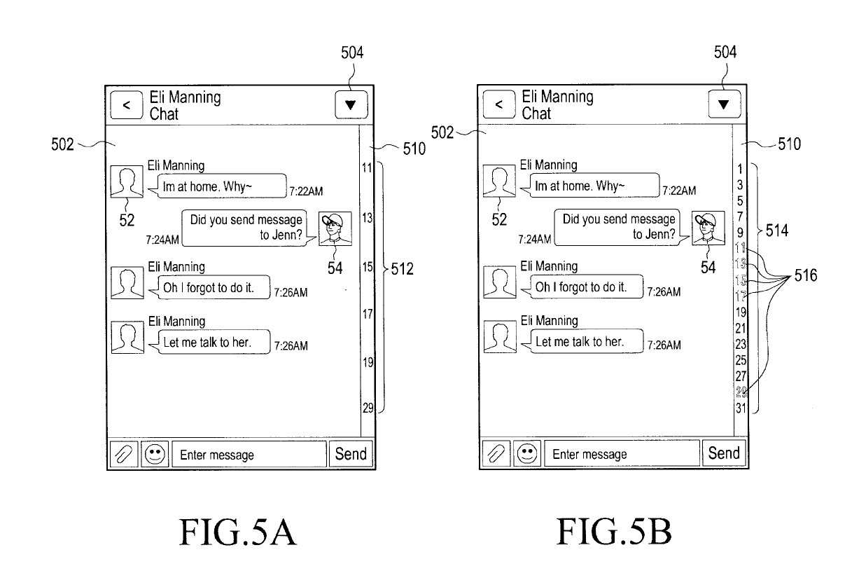

An operation for displaying a date on a timeline bar in various example embodiments of the present disclosure will be described. FIG. 4 is a flowchart illustrating an operation for displaying a timeline bar in a dialog window according to an embodiment of the present disclosure, and FIGS. 5A and 5B illustrate example timeline bars displayed in a dialogue window according to an embodiment of the present disclosure.

Referring to FIG. 4, the electronic device 100 may compare a number “M” days on which dialogues have been made, with a predetermined number “N” in operation 410. M is the number of days from a starting day of the dialogues to an ending day of the dialogues. N may be a maximum number of days that can be displayed on a timeline bar. The maximum number of days may vary depending on a messenger service policy and the size of the touch screen 140 in the electronic device 100.

If M is equal to or smaller than N, the electronic device 100 may display all of the days with the dialogues on the timeline bar in operation 420. For example, referring to FIG. 5A, the electronic device 100 may display all days of dialogues from the starting day to the ending day on a timeline bar 510 in a dialogue window 502, in which a user 54 of the electronic device 100 and the other user 52 conversed, as illustrated in FIG. 5A.

On the other hand, if M is larger than N, the electronic device 100 may display the days of the dialogues at M/N intervals on the timeline bar in operation 430.

For example, if M is larger than N, the electronic device 100 may display the days of the dialogues at M/N intervals on the timeline bar 510 in the dialogue window 502 in which the user 54 and the other user 52 are conversing, as illustrated in FIG. 5B. For example, if M/N is 2, the electronic device 100 may display day “1” to day “31” 514 every other day, as in “1, 3, 5, 7, 9 . . . 29, 31.” To distinguish days 516 with dialogue messages from days without dialogue messages, the days 516 may be displayed differently from the other days. For example, the electronic device 100 may highlight the days 516.

In one embodiment of the present disclosure, a timeline bar and dates represented on the timeline bar may be displayed in various manners. For example, each date may be represented in day, in day and month, in day, month, and year, or in month and year. The timeline bar may be disposed in a left, right, upper, or lower part of a dialogue window. Or time may be displayed in years in the upper part of the dialogue window, whereas time may be displayed in months in the right part of the dialogue window.

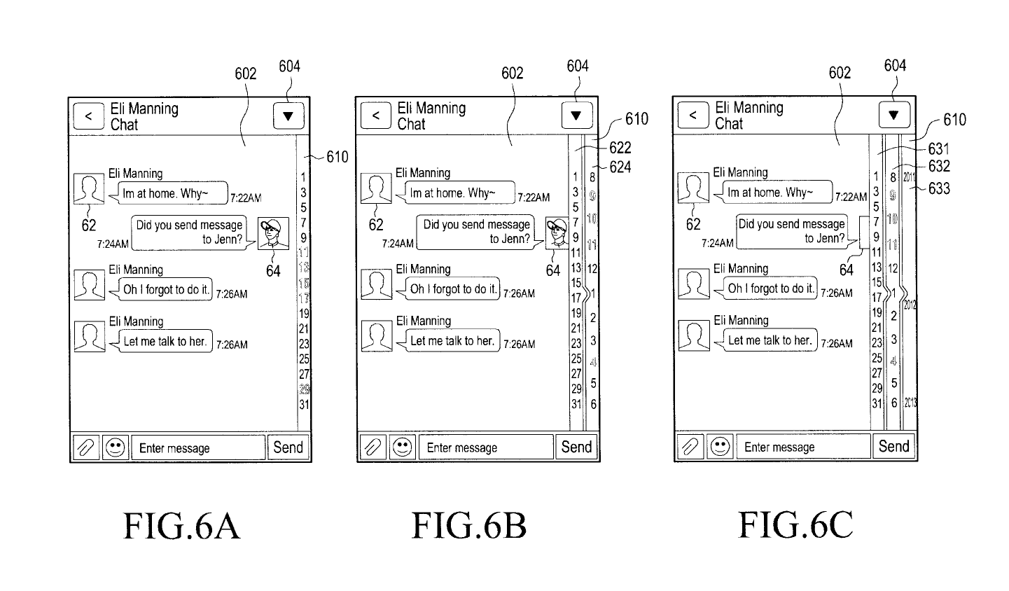

FIGS. 6A, 6B, and 6C illustrate example methods for displaying dates on a timeline bar according to an embodiment of the present disclosure.

Referring to FIG. 6A, the electronic device 100 may display days on a timeline bar 610 in a dialogue window 602 in which a user 64 of the electronic device 100. The user 64 may select a desired day on the timeline bar 610 to trigger display of messages from the selected day.

Referring to FIG. 6B, the electronic device 100 may display time in days 622 and months 624 on the timeline bar 610 in the dialogue window 602 in which the user 64 of the electronic device 100 is talking with the other user 62. The user 64 may select a desired date in day and month on the timeline bar 610 to trigger display of messages from the selected day and month.

Referring to FIG. 6C, the electronic device 100 may display time in days 631, months 632, and years 633 on the timeline bar 610 in the dialogue window 602 in which the user 64 of the electronic device 100 is talking with the other user 62. The user 64 may select a desired date in day, month, and year on the timeline bar 610 to trigger display of messages from the selected day, month and year.

The electronic device 100 may select a date display scheme through a date display scheme selection button 604.

7A, 7B, and 7C illustrate example methods for displaying a timeline bar in a dialogue window according to an embodiment of the present disclosure.

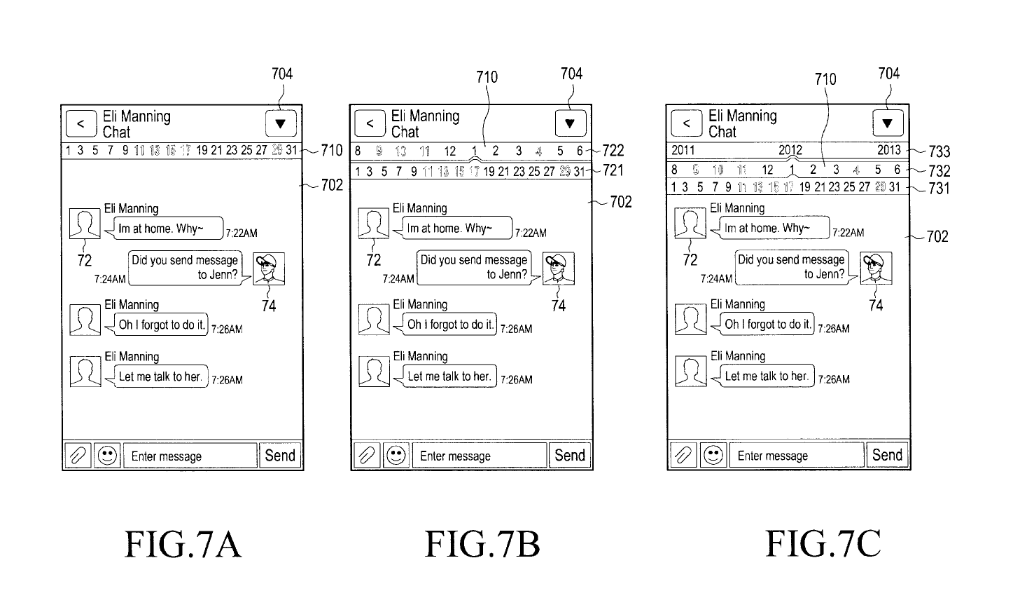

Referring to FIG. 7A, the electronic device 100 may display a timeline bar 710 containing days in an upper part of a dialogue window 702 in which a user 74 of the electronic device 100 is talking with the other user 72. The user 74 may select a desired day on the timeline bar 710 to trigger display of messages from the selected day.

Referring to FIG. 7B, the electronic device 100 may display time in days 721 and months 722 on the timeline bar 710 in the upper part of the dialogue window 702 in which the user 74 of the electronic device 100 is talking with the other user 72. The user 74 may select a desired date in day and month on the timeline bar 710 to trigger display of messages from the selected day and month.

Referring to FIG. 7C, the electronic device 100 may display time in days 731, months 732, and years 733 on the timeline bar 710 in the upper part of the dialogue window 702 in which the user 74 of the electronic device 100 is talking with the other user 72. The user 74 may select a desired date in day, month, and year on the timeline bar 710 to trigger display of messages from the selected day, month and year.

The electronic device 100 may select a date display scheme through a date display scheme selection button 704.

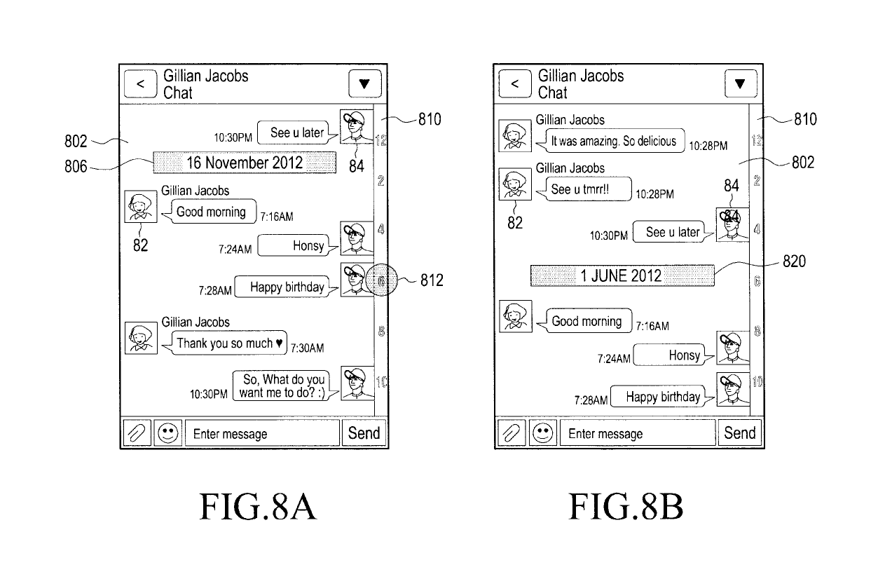

FIGS. 8A and 8B illustrate screens displayed upon selection of a date on a timeline bar according to an example embodiment of the present disclosure.

If a user 84 of the electronic device 100 is talking with the other user 82 on Nov. 16, 2012, the electronic device 100 may display a dialogue window 802 as illustrated in FIG. 8A. The electronic device 100 may display a timeline bar 810 containing months, for example, in a right part of the dialogue window 802 and may select a specific month 812 corresponding to June from among the months represented on the timeline bar 810 according to a user input.

Upon user selection of the specific month 812, that is, June, the electronic device 100 may display the contents of a dialogue made on the first day of the selected month, that is, Jun. 1, 2012 as indicated by reference numeral 820 in FIG. 8B. The electronic device 100 may receive the contents of a dialogue made in the selected month from the messenger server 102 through the communication unit 120 and display the received contents of the dialogue. Or the electronic device 100 may search for the contents of the dialogue made in the selected month in the memory 130 and display the detected contents of the dialogue.

The proposed electronic device and method for providing a messenger service in the electronic device may be implemented as computer-readable code in a computer-readable recording medium. The computer-readable recording medium may include any kind of recording device storing computer-readable data. Examples of the recording medium may include Read Only Memory (ROM), Random Access Memory (RAM), optical disk, magnetic tape, floppy disk, hard disk, non-volatile memory, and the like, and may also include the medium that is implemented in the form of carrier waves (for example, transmission over the Internet). In addition, the computer-readable recording medium may be distributed over the computer systems connected over the network, and computer-readable codes may be stored and executed in a distributed manner.

As is apparent from the foregoing description, once a user selects a specific time point, for example, a time point represented as an hour, a day, a week, a month, and/or a year, an electronic device can immediately display the contents of a dialogue made in the selected time point.

Therefore, the user does not need to repetitiously scroll through messages, starting from a current message, or to search for a message sent or received at a desired time point by checking back dialogues one by one, starting from a current dialogue.

While the disclosure has been shown and described with reference to certain example embodiments thereof, it will be understood by those skilled in the art that various changes in form and details may be made therein without departing from the ambit of the disclosure as defined by the appended claims and their equivalents.

What is claimed is:

1. An electronic device comprising:
a display configured to: display a timeline bar in a dialogue window of a messenger application, the timeline bar including a plurality of time points, each time point associated with archived messages; and
a controller configured to:
receive a selection of one of the time points and retrieve the archived messages associated with the selected one of the time points, and
display the retrieved archived messages in the display.

2. The electronic device of claim 1, further comprising a communication unit configured to receive the archived messages associated with the selected one of the time points from an external server.

3. The electronic device of claim 1, wherein the timeline bar represents time points in units including at least one of:
an hour, day, week, month, and year.

4. The electronic device of claim 1, wherein the timeline bar is displayed in a portion of the dialogue window including least one of an upper portion, a lower portion, a left portion, and a right portion.

5. The electronic device of claim 1, further comprising:
in response to a number of the plurality of time points being equal to or smaller than a predetermined number indicating a maximum number of time points displayable on the display, displaying the plurality of time points on the timeline bar.

6. The electronic device of claim 1, further comprising:
in response to a number of the plurality of time points being larger than a predetermined number indicating a maximum number of time points displayable on the display, displaying the plurality of time points at intervals according to a quotient generated by dividing the number by the predetermined number.

7. The electronic device of claim 1, wherein each time point associated with archived messages is displayed distinguishably from other time points that are not associated with archived messages.

8. The electronic device of claim 7, wherein each time point associated with archived messages is displayed distinguishably via a visual highlight.

9. The electronic device of claim 3, wherein the timeline bar represents time points in units including at least two of the hour, day, week, month, and year, the timeline bar having a first bar associated with a first of the at least two of the hour, day, week, month, and year, and having a second bar associated with a second of the at least two of the hour, day, week, month, and year.

10. The electronic device of claim 9, the controller further configured to:
receive a first selection of the first of the at least two of the hour, day, week, month, and year from the first bar;
receive a second selection of the second of the at least two of the hour, day, week, month, and year from the second; and
detect the one of the time points based on the first selection and the second selection.

11. A method for providing a messenger service in an electronic device, the method comprising:
displaying, via a display, a timeline bar in a dialogue window of a messenger application, the timeline bar including a plurality of time points, each time point associated with archived messages; and
receiving, via a controller, a selection of one of the time points and retrieving the archived messages associated with the selected one of the time points, and
displaying the retrieved archived messages.

12. The method of claim 11, further comprising receiving the archived messages associated with the selected one of the time points from an external server.

13. The method of claim 11, wherein the timeline bar represents time points in units including at least one of:
an hour, day, week, month, and year.

14. The method of claim 11, wherein the timeline bar is displayed in a portion of the dialogue window including least one of an upper portion, a lower portion, a left portion, and a right portion.

15. The method of claim 11, further comprising:
in response to a number of the plurality of time points being equal to or smaller than a predetermined number indicating a maximum number of time points displayable on the display, displaying the plurality of time points on the timeline bar.

16. The method of claim 11, further comprising:
in response to a number of the plurality of time points being larger than a predetermined number indicating a maximum number of time points displayable on the display, displaying the plurality of time points at intervals according to a quotient generated by dividing the number by the predetermined number.

17. The method of claim 11, wherein each time point associated with archived messages is displayed distinguishably from other time points that are not associated with archived messages.

18. The method of claim 17, wherein each time point associated with archived messages is displayed distinguishably via a visual highlight.

19. The method of claim 13, wherein the timeline bar represents time points in units including at least two of the hour, day, week, month, and year the timeline bar having a first bar associated with a first of the at least two of the hour, day, week, month, and year, and having a second bar associated with a second of the at least two of the hour, day, week, month, and year.

20. The method of claim 19, further comprising:
receiving a first selection of the first of the at least two of the hour, day, week, month, and year from the first bar;
receiving a second selection of the second of the at least two of the hour, day, week, month, and year from the second; and
detecting the one of the time points based on the first selection and the second selection.
